(19) United States
(12) Patent Application Publication
(10) Pub. No.: US 2009/0266784 A1
(43) Pub. Date: Oct. 29, 2009

(54) CLOSING ELEMENT FOR CONTAINERS

(75) Inventor: Pierluigi Garuti, Sant'Agata Bolognese(Bologna) (IT)

Correspondence Address: Pearne & Gordon LLP, 1801 East 9th Street, Suite 1200, Cleveland, OH, 44114-3108, US

(73) Assignee: PELLICONI & C. S.P.A., 40064 Ozzano Emilia (Bologna) (IT)

(21) Appl. No.: 12/375,629

(22) PCT Filed: Jul. 30, 2007
(86) PCT No.: PCT/IB07/02178

§ 371 Date: Jan. 29, 2009

(30) Foreign Application Priority Data
Jul. 31, 2006 (IT) BO2006A000579

(51) Int. Cl. B65D 41/00; B23P 17/00

(52) U.S. Cl. 215/316; 29/592

(57) ABSTRACT

A closing element (3) for containers (1), in particular for fizzy drinks in which the container (1) is of the type with a neck on which there is an annular projection (2); the closing element comprises a crown cap (4) having an upper surface (5) and a lateral surface (6). The lateral surface (6) has a plurality of teeth (8), and the cap (4) can be applied to close the container (1). A covering element (10) is applied on the crown cap (4) to cover at least the upper and lateral surfaces of the cap.

### TECHNICAL FIELD

The present invention relates to a closing element for containers.

In particular, the present invention relates to a closing element for containers for fizzy drinks using caps of the crown type and a method for making a closing element for containers.

### BACKGROUND ART

As is known, crown caps are made from a sheet of metal material on which, by means of what is usually a lithographic-type process, a plurality of circular logos are printed.

The circular logos have a predetermined colour or a particular figurative element which identify the type of drink contained in the container or the drink manufacturer. They basically serve the dual purpose of identifying the product and making it recognisable in terms of both advertising and consumer perception.

The logos form the visible outer portion of the cap and are made on the metal sheet in a plurality of regularly spaced rows, positioned in such a way that they are offset from one another so that they substantially cover the entire usable surface of the metal sheet.

Once the surface of a relative metal sheet has been filled with the circular logos, the sheet is inserted in a punching machine which, in a single step, cuts each metal circular element, whose diameter is defined by the diameter of the lithographed logo, and makes the cap directly in a crown shape with the circular elements in the final pre-bottling configuration.

The caps made in this way and already in their definitive form, therefore including aesthetic decoration, are inserted in a station for making the sealing element, usually consisting of a seal made of plastic material.

This type of cap has several disadvantages.

Creating the cap aesthetic decoration before forming the cap itself in some cases results in decoration surface finish defects.

When the metal circular element is punched to form the crown cap and the cap teeth are made, often the lithographed portion at the part of the circular metal element occupied by the teeth is at least partially worn away.

Said phenomenon is more pronounced in the inner zone of the cap at the toothing, which is the zone most subject to rubbing because it is the zone in contact with the bottle neck and where the metal material is not lithographed.

The upper central portion of the cap may also be ruined in the punching process.

Any type of rubbing involves a risk of the lithographed part being scratched.

Moreover, said first disadvantage is the cause of a second and no less important disadvantage of prior art caps.

Rubbing of the decorative part may lead to the formation of rust in the scratched parts, above all at the teeth, with consequent negative repercussions on the client perception of the drink contained in the container and the possibility of a loss of cap sealing efficiency.

The formation of rust is also a problem if the bottles are kept in humid environments for a long time, for example, storage warehouses.

### DISCLOSURE OF THE INVENTION

The aim of the present invention is therefore to overcome the above-mentioned disadvantages by providing a closing element for containers and a process for making a closing element for containers which is economical, strong and easy to implement.

### BRIEF DESCRIPTION OF THE DRAWINGS

The technical features of the invention, in accordance with the aforementioned aims, are clearly indicated in the claims herein and the advantages of the invention are more apparent in the detailed description which follows, with reference to the accompanying drawings, which illustrate a preferred embodiment by way of example only and without limiting the scope of the invention, in which:

FIG. 1 is a schematic perspective view of a bottle and a closing element in accordance with the present invention;

FIG. 2a is a schematic perspective view of a detail of the closing element from FIG. 1;

FIG. 2b is a schematic perspective view from a different angle of the detail from FIG. 2a;

FIG. 3 is a cross-section of a detail of the closing element from FIG. 1;

FIGS. 4 to 8 illustrate the various steps of the process for making the closing element in accordance with the invention;

FIG. 9 is a schematic plan view of a detail of the closing element in accordance with the present invention.

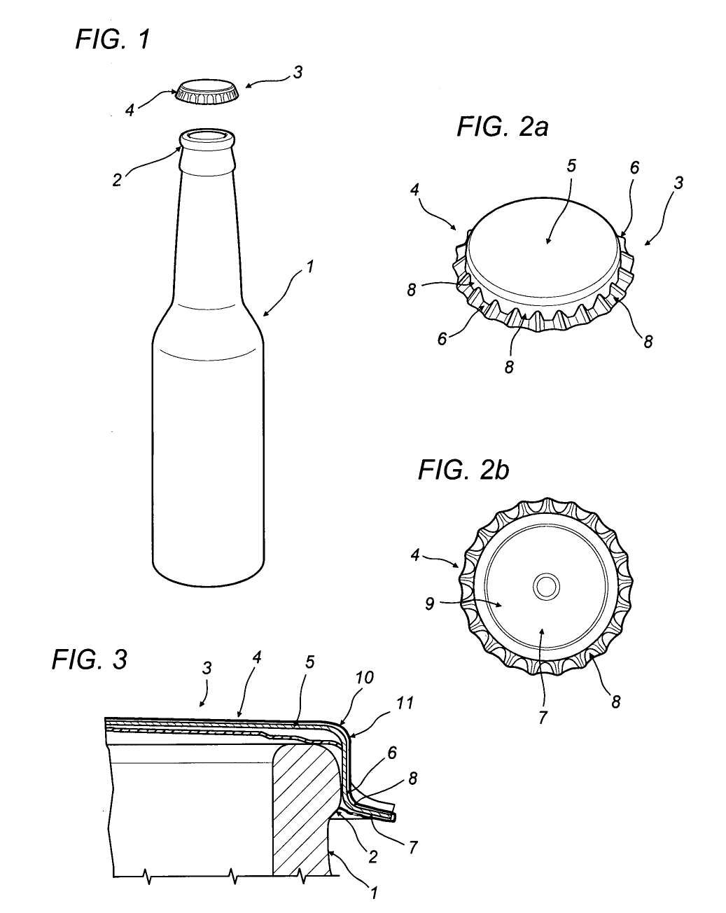

### DETAILED DESCRIPTION OF THE PREFERRED EMBODIMENTS OF THE INVENTION

With reference to the accompanying drawings, the numeral 1 denotes a bottle which, close to its mouth, has an annular projection 2 made on the bottle neck close to the mouth. The mouth is closed by a closing element 3.

The closing element 3 comprises a crown cap 4 having an upper surface 5, said surface 5 basically forming an outer portion of the cap 4.

The crown cap 4 also comprises a lateral surface 6 and an inner surface 7, visible in FIG. 2b.

A plurality of teeth 8 are made on the lateral surface 6. The teeth are designed to be connected with a forced fit, by plastic deformation, on the annular projection 2.

As illustrated in FIG. 2b, the inner surface 7 of the crown cap 4, that is to say, the surface facing towards the mouth of the bottle 1, is covered by a disk 9 made of a yielding material which acts as a seal to prevent the contents of the bottle 1 from escaping.

FIG. 3 shows how the closing element 3 also comprises a cap 4 covering element 10, consisting of a piece 11 of heat-shrink plastic material, said piece 11 applied to the crown cap 4. The piece 11 covers both the upper surface 5 of the cap 4 and the toothed lateral surface 6, at least partly turned under so that it rests on the inner surface 7 of the cap, at the toothing.

Advantageously, the piece 11 is circular and is made of a heat-shrink plastic material with shrinking that varies according to the radius.

In practice, as shown in FIG. 9, the circular piece 11 has a central portion 102 with a diameter D equal or close to the diameter of the upper surface 5 of the cap 4 and a peripheral portion 103 consisting of a ring 104, designed to cover the lateral surface 6 of the cap 4 and to be turned under it on the inner surface 7 of the cap 4.

The selection of the heat-shrink properties of the material used is such that, the temperature being equal, the ring 104 shrinks differently compared with the central portion 102 (if that happens). However, it is essential that piece 11 shrinking occurs first at the ring 104 and only afterwards (if present) for the central portion 102, with a speed which falls as the distance from the centre of the piece 11 is reduced.

Advantageously, the perimeter of the ring 104 is made of an elastic material 105 which shrinks less than the ring 104, so that it does not tend to open during heating. Otherwise, the material might not be turned under on the inner surface 7 of the cap 4.

The upper surface 5 of the cap 4 is preferably covered with an adhesive paint which allows the piece 11 to be held on the cap 4 during the step of placing and subsequent heating of the piece 11.

According to another embodiment, not illustrated, the piece 11 of plastic material has its own adhesive portion which adheres to the upper surface 5 of the cap.

As illustrated in FIG. 6, the piece 11 of plastic material bears a logo 12. Advantageously, the logo 12 may show the name of the drink manufacturer and/or the type of drink contained in the bottle.

The piece 11 of plastic material also comprises a band 13 coloured according to the type of drink present in the container.

The logo 12 and the coloured band 13 form closing element 3 identification means 14.

The invention also relates to a method for making a closing element 3 as described above.

In particular, the method for making the closing element 3 starts with forming the crown cap 4.

The crown cap 4 is made in a punching machine, of the known type and therefore not illustrated, starting with a metal sheet having a uniform colour, that is to say, without any type of decorative element indicating the manufacturer of the drink contained in the bottle 1 on which the cap 4 will be applied.

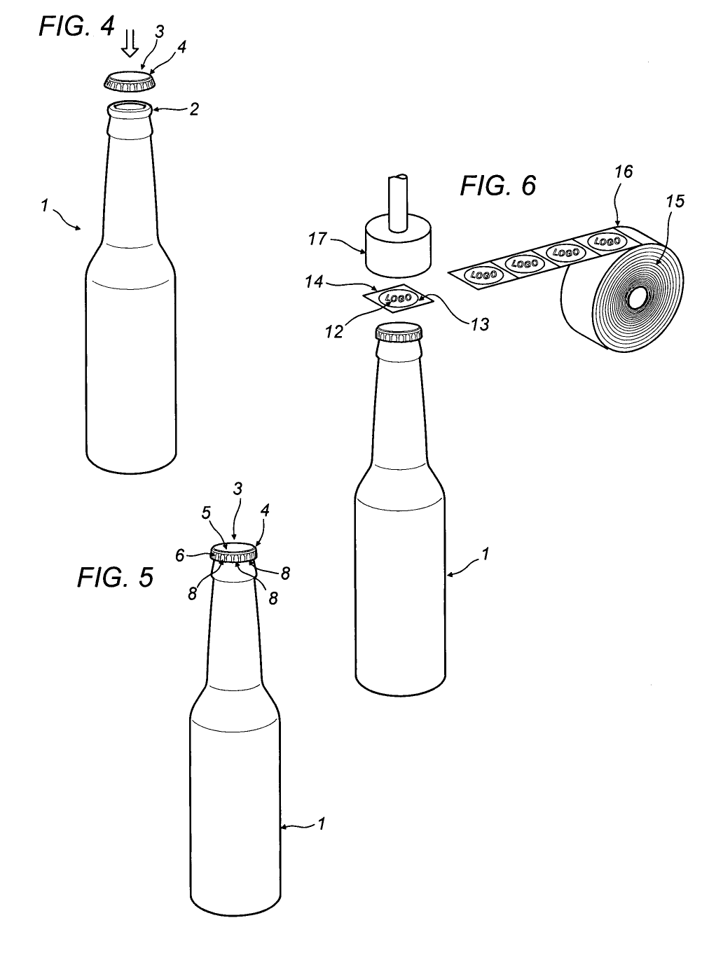

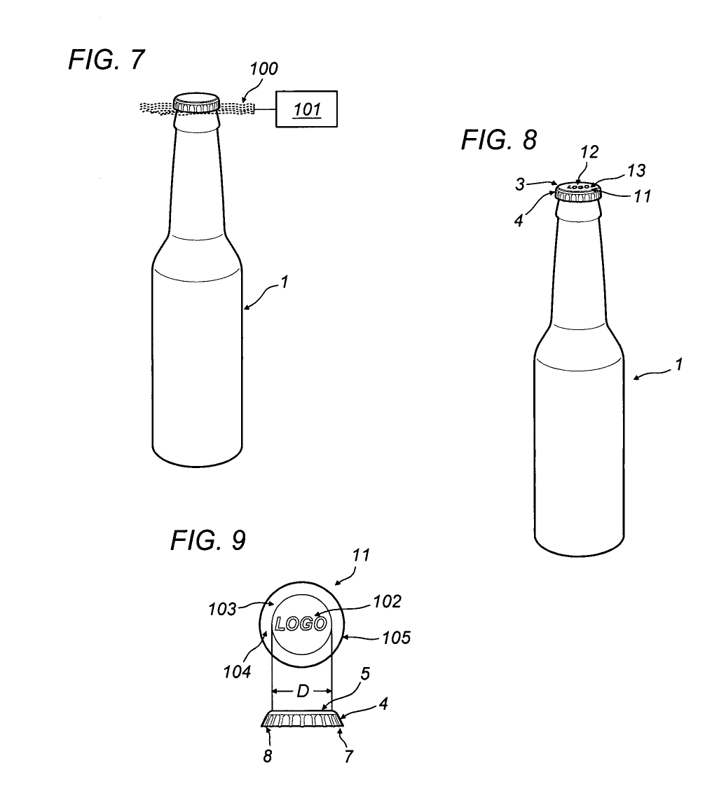

As illustrated in FIGS. 4 to 8, once the crown cap 4 has been made it is applied with a forced fit, by plastic deformation, to the neck of the bottle 1, at the annular projection 2.

The bottle 1 is sealed and the closing element 3 is stably connected to the bottle 1.

The bottle 1 is sent to a subsequent station for application of the covering element 10.

As illustrated in FIG. 6, a web 16 of plastic material is unwound from a reel 15. According to a first embodiment, said web already bears the decorative elements forming the logos 12 of each piece 11.

The web 16 is unwound and cutting means of the known type and therefore not illustrated are used to obtain one after another the various pieces 11 to be applied to the relative bottles 1.

Once a piece 11 has been cut, it is positioned by a punch 17 on the cap 4 of a relative bottle 1.

After piece 11 positioning on the cap 4, the bottle 1 and, in particular, the zone at the neck of the bottle 1, is struck by a laminar jet 100 of hot air dispensed by a heating device 101, its temperature and time controlled to allow the piece 11 to completely adapt to the shape of the cap 4 and turn under the toothing 8, thus also resting on the inner part 7 of the cap 4.

According to another embodiment, not illustrated, the feed reel 15 may contain a web of plastic material which is not customised, that is to say, has no type of logo or coloured band indicating the type of product.

In such a case the anonymous web is unwound from the reel and, upstream of the station for positioning and fixing the pieces 11 to the caps 4, there is a zone for customising each piece 11 of plastic material, where the logos 12 and/or the coloured bands 13 are created, for example by painting with a spray gun.

Advantageously, said solution allows instant customisation of each piece 11, allowing continuous diversified production of bottles 1 containing various types of drinks.

According to another embodiment, the punch 17 also acts as a heating device, allowing the piece 11, made of heat-shrink material, to be fixed to the cap 4.

Another alternative embodiment involves the use of a blow-drier which dispenses a continuous jet of hot air as the piece 11 heating device, as an alternative to the punch 17.

In this case the bottle 1 will rotate about its axis to allow uniform heating of the entire surface at the bottle neck.

According to another embodiment, the piece 11 of plastic material is not made of heat-shrink material, but comprises an adhesive portion.

The adhesive portion of the piece 11 is therefore drawn near the crown cap 4 and glued to it. In this way, the piece 11 perfectly adheres to the crown cap 4.

The invention brings important advantages.

Firstly, making the crown cap aesthetic decoration, that is to say, the relative colouring or writing of the logo, after applying the closing element to the bottle allows any possible cap rubbing to be avoided, in this way preventing the cap, which plays an important role in client perception of the product, from being ruined.

The application of a piece of plastic material after bottling also eliminates the problem of rust formation, above all, at the teeth of the crown cap.

The invention described above is susceptible of industrial application and may be modified and adapted in several ways without thereby departing from the scope of the inventive concept. Moreover, all details of the invention may be substituted by technically equivalent elements.

1. A method for making a closing element (3) for containers (1), in particular for fizzy drinks wherein the container (1) is of the type with a neck on which there is an annular projection (2), characterised in that it comprises the steps of:
making a crown cap (4) having an upper surface (5) and a lateral surface (6);
applying the crown cap (4) to the neck of the container, at the annular projection (2);
applying a covering element (10), having a piece (11) of plastic material bearing a logo (12) or a coloured band (13), to the crown cap (4).

2. The method according to claim 1, wherein the piece (11) of plastic material is a circular piece (11) of heat-shrink plastic material, characterised in that the step of applying the covering element (10) to the crown cap (4) comprises the steps of:
applying the piece (11) of heat-shrink plastic material to the crown cap (4), said piece (11) having shrinking that varies according to the radius of the piece;
heating the piece (11) of plastic material using a jet of hot air to fix the piece (11) to the cap (4) and adapt it to the shape of the cap (4).

3. The method according to claim 2, characterised in that the step of applying the piece (11) of plastic material to the crown cap (4) comprises the step of obtaining the piece (11) from a web (16) wound in reel (15), said web (16) bearing the logos (12) and coloured bands (13) one after another.

4. The method according to claim 2, characterised in that the step of applying the piece (11) of plastic material to the crown cap (4) comprises the steps of:
obtaining the piece (11) from a web of heat-shrink material wound in a reel;
creating the logo (12) and/or coloured band (13) on the piece (11) by painting with a spray gun.

5. The method according to claim 1, wherein the piece (11) of plastic material comprises an adhesive portion, characterised in that the step of applying the covering element (10) to the crown cap (4) comprises the step of drawing the adhesive portion of the piece (11) near to the upper surface (5) of the crown cap (4).

6. A closing element for containers, in particular for fizzy drinks wherein the container (1) is of the type with a neck on which there is an annular projection (2), characterised in that it comprises
a crown cap (4) having an upper surface (5) and a lateral surface (6), the lateral surface (6) having a plurality of teeth (8), it being possible to apply the cap (4) to close the container (1);
a covering element (10) for the cap (4) comprising a piece (11) of plastic material applied on the crown cap (4) and designed to cover at least the upper and lateral surfaces (5, 6) of the cap (4), the covering element (10) comprising container (1) identification means (14).

7. The closing element according to claim 6, characterised in that the plastic material of the piece (11) is a heat-shrink material with differentiated shrinking.

8. The closing element according to claim 6, characterised in that the piece (11) is circular and the material of which the piece (11) is made is a heat-shrink material with shrinking that varies according to the distance from the centre of the piece (11).

9. The closing element according to claim 8, characterised in that the piece (11) comprises a circular central portion (102) having a diameter (D) and a peripheral portion (103) consisting of a ring (104), said ring (104) shrinking more than the central portion (102).

10. The closing element according to claim 6, characterised in that the piece (11) of plastic material has an adhesive portion.

11. The closing element according to claim 10, characterised in that the adhesive portion of the piece (11) adheres at least to the upper surface (5) of the crown cap (4).

12. The closing element according to claim 6, characterised in that the identification means (14) comprise a logo (12) showing the type of drink and/or the drink manufacturer.

13. The closing element according to claim 6, characterised in that the identification means (14) comprise at least a coloured band (13).

14. A container for drinks, characterised in that it comprises a closing element (10) according to claim 6.
